(19) United States
(12) Patent Application Publication
(10) Pub. No.: US 2006/0239652 A1
(43) Pub. Date: Oct. 26, 2006

(54) Audio/video control mechanism and method

(75) Inventor: Bor-Sung Liang, Hsinchu City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Sunplus Technology Co., Ltd.

(21) Appl. No.: 11/254,656

(22) Filed: Oct. 21, 2005

(30) Foreign Application Priority Data
Apr. 11, 2005 (TW) 094111391

(51) Int. Cl. H04N 7/00

(52) U.S. Cl. 386/96

(57) ABSTRACT

The present invention describes an audio/video control mechanism including a storage device, a first selector, a computer system, an input device, an audio/video playback controller, a second selector, a third selector, an image output device, and a sound output device. With this mechanism, the computer system can automatically pass the control right of playing an audio/video file to the audio/video playback controller according to the audio/video playback requirements and file format, so as to achieve the purpose of power saving. In addition, the invention also discloses an audio/video control method.

### BACKGROUND OF THE INVENTION

1. Field of the Invention

The present invention generally relates to an audio/video control mechanism, and more particularly to an audio/video control mechanism and method that adopts a computer system capable of automatically passing the control right of playing an audio/video file to the audio/video playback controller according to the audio/video playback requirements and file format, so as to achieve the purpose of saving power.

2. Description of the Related Art

As present personal computers (PCs) become more powerful and have plentiful multimedia functions, information appliances tend to be consumer electronic products, and some are used as VCD and DVD playbacks. However, the architecture of the present PC usually comes with a CPU of over several GHz plus a large main board and peripherals that consume an electric power of over several hundred watts. Furthermore, the high power consumption requires a fan for dissipating heat, and thus noises are produced easily during the operation of the fan. If a PC enters into an audio/video playback mode, it will be a tremendous waste to use the PC to execute all audio/video playback functions. Further, the noise produced during the operation of a fan also seriously affects users.

On the other hand, the playback chip of a DVD player adopts the design of an application specific integrated circuit (ASIC) featuring low power consumption and requiring no heat dissipation, and thus can satisfy the audio/video playback requirements. Since the functions are simple and the playback formats are limited, the DVD player cannot achieve the functions of a PC.

Refer to U.S. Pat. No. 6,006,285 entitled “Computer system capable of playing audio CDs in a CD-ROM drive independent of an operating system (filed on Apr. 23, 1997 and published on Dec. 21, 1999) and U.S. Pat. No. 6,279,056 entitled “Computer system capable of playing audio CDs in a CD-ROM drive independent of an operating system (filed on Sep. 3, 1999 and published on Aug. 21, 2001) for the prior art personal computer having a CD or DVD playback function. Both prior arts teach a computer system capable of playing audio CDs in a CD-ROM drive independent of an operating system. However, these prior arts only have the CD playback function and lack of a handshaking mechanism between the CPU and the CD-ROM player. In other words, if a CD cannot be played in the CD-ROM player, then the CD-ROM player will pause and cannot pass the control right to the CPU of the PC, and thus causing a waste to computer resources.

In view of the foregoing shortcomings, an audio/video control mechanism and method is needed, so that an audio/video playback function originally used in a PC mode is processed by an audio/video playback controller instead of the CPU. In an audio/video playback, the PC will automatically enter into a sleep mode or will be turned off. Since the audio/video playback controller has low power consumption and requires no heat dissipation, therefore energy can be saved and noises of a fan can be avoided. If the audio/video playback controller stops operating, the PC will be waken automatically to return to its original status. However, if the audio/video playback controller cannot play a file format, then the PC will play the file by software.

### SUMMARY OF THE INVENTION

The primary objective of the present invention is to provide an audio/video control mechanism capable of automatically switching the connection of storage and I/O devices according to the audio/video operating requirements.

Another objective of the present invention is to provide an audio/video control mechanism that concurrently has the multi-functions of a PC and the low power consumption feature of an audio/video playback controller.

Another objective of the present invention is to provide an audio/video control mechanism capable of automatically switching a PC and an audio/video playback controller to enter into a power-saving mode according to the audio/video operating requirements.

A further objective of the present invention is to provide an audio/video control mechanism, such that if a PC encounters different file formats that can be played by the audio/video playback controller, the control right will be passed to the audio/video playback controller. If a file format cannot be played by the audio/video playback controller, then the PC can still play the file.

Another further objective of the present invention is to provide an audio/video control mechanism capable of switching the connection of storage and I/O devices according to the audio/video operating requirements.

To achieve the foregoing objectives, the audio/video control mechanism in accordance with the present invention comprises: a storage device for storing at least one audio/video file; a first selector with its input end coupled to an output end of the storage device; a computer system coupled to a first output end of the first selector; an input device coupled to the computer system; an audio/video playback controller coupled to a second output end of the first selector and the computer system for handshaking with the computer system; a second selector with its first input end coupled to an output end of the computer system; a second input end coupled to an output end of the audio/video playback controller; a third selector with its first input end coupled to an output end of the computer system; a second input end coupled to an output end of the audio/video playback controller; an image output device coupled to an output end of the second selector for outputting an image; and a sound output device coupled to an output end of the third selector for outputting a sound. With the foregoing mechanism, the computer system automatically passes the control right of playing an audio/video file to the audio/video playback controller according to the audio/video playback requirements and file format, so as to achieve the purpose of power saving.

To achieve the foregoing objectives, the audio/video control method in accordance with the present invention comprises the steps of: connecting an image output and a sound output of a storage device to a computer system; the computer system receiving an audio/video playback request and designating an audio/video file in the storage device for the playback; switching the connection of the image output and the sound output outputted by the storage device to an audio/video playback controller; the computer system sending out a control signal to the audio/video playback controller; the audio/video playback controller starting the audio/video playback; the computer system entering into a sleep mode or shutting down; sending out a signal to the computer system if the audio/video playback controller ends or terminates the audio/video playback; and switching the connection of the image output and sound output of the storage device to the computer system, and the computer system resuming the execution of other functions from the sleep mode or shutdown.

To make it easy for our examiner to understand the structure, characteristics and purpose of the present invention, a preferred embodiment accompanied with the drawings will be described below.

### BRIEF DESCRIPTION OF THE DRAWINGS

FIG. 1 is a schematic block diagram of an audio/video control mechanism according to a preferred embodiment of the present invention;

FIG. 2 is a schematic view of the status of an audio/video control mechanism according to a preferred embodiment of the present invention;

FIG. 3 is a flow chart of an audio/video control method according to a preferred embodiment of the present invention;

FIGS. 4A and 4B are schematic views of an audio/video control method that waits for a response from the audio/video playback controller 5 after the computer system 3 sends out a control signal according to the present invention;

FIG. 5 is a schematic view of a playback procedure when the audio/video control method of the present invention is triggered by a special event, the central processing unit 31 of the computer system 3 resumes its normal operation and takes over the playback procedure of the audio/video file.

### DETAILED DESCRIPTION OF THE PREFERRED EMBODIMENTS

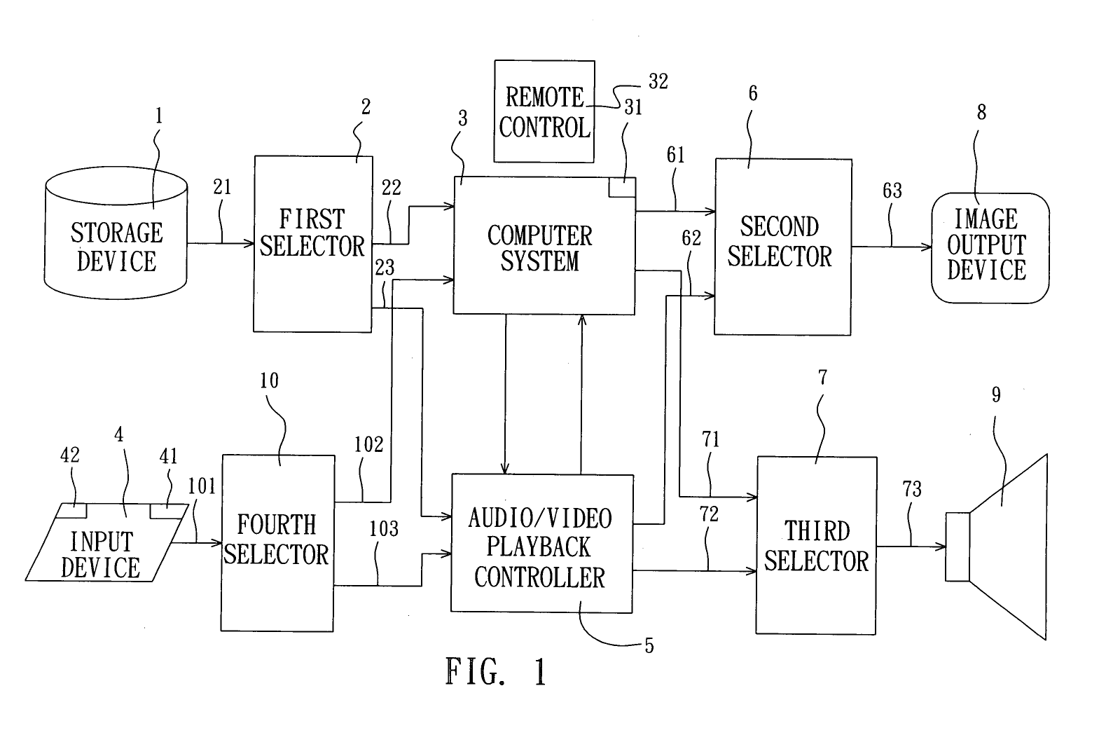

Referring to FIG. 1 for a block diagram of an audio/video control mechanism according to a preferred embodiment of the present invention, the audio/video control mechanism of the invention comprises a storage device 1, a first selector 2, a computer system 3, an input device 4, an audio/video playback controller 5, a second selector 6, a third selector 7, an image output device 8 and a sound output device 9.

The storage device 1 is provided for storing at least one audio/video file including but not limited to a hard disk drive (H.D) or an optical disk drive. The first selector 2 including but not limited to a demultiplexer has an input end 21 and two output ends 22, 23; wherein the input end 21 is coupled to the output end (not shown in the figure) of the storage device 1.

The computer system 3 including but not limited to a general desktop computer or notebook computer has a central processing unit (CPU) 31, and the computer system 3 is coupled to the first output end 22 of the first selector 2 and has a playback program (not shown in the figure), such that if the audio/video playback controller 5 cannot play an audio/video file, the playback program will take over and play the audio/video file by software.

The input device 4 including but not limited to a mouse or a keyboard is coupled to the computer system 3 for inputting signals to the computer system 3. The audio/video playback controller 5 is a controller chip of the DVD player (not shown in the figure) including but not limited to an application specific integrated circuit (ASIC). Since the ASIC features low power consumption, therefore no fan is needed for heat dissipation and the noises produced by the operation can be avoided. However, the formats of the decodable audio/video file are relatively lesser and these formats include but not limited to MPEG2 or MPEG4. The DVD player can be built in the computer system 3 or connected to the computer system 3 through a port including but not limited to a USB port connected to the computer system 3. The audio/video playback controller 5 is coupled to a second output end 23 of the first selector 2 and the computer system 3 and capable of carrying out a handshaking procedure with the computer system 3, such that the computer system 3 automatically passes the control right of playing an audio/video file to the audio/video playback controller 5 according to the audio/video playback requirements and file format, so as to achieve the power-saving purpose. The method of passing the control right will be described below. Further, the audio/video playback controller 5 can enter into a sleep mode to save power when no request for playback is received.

The second selector 6 including but not limited to a multiplexer has two input ends 61, 62 and an output end 63; wherein the input end 61 is coupled to an output end of the computer system 3, and its second input end 62 is coupled to an output end of the audio/video playback controller 5, and the output end 63 is coupled to the image output device 8.

The third selector 7 including but not limited to a multiplexer has two input ends 71, 72 and an output end 73; wherein the input end 71 is coupled to an output end of the computer system 3, and its second input end 72 is coupled to an output end of the audio/video playback controller 5, and the output end 73 is coupled to the sound output device 9.

The image output device 8 including but not limited to a screen of the PC 3 is coupled to an output end 63 of the second selector 6 for outputting images. The sound output device 9 including but not limited to a speaker is coupled to an output end 73 of the third selector 7 for outputting sounds.

The input device 4 of the computer system 3 further includes a hot key 41, such that when the hot key 41 is pressed, the computer system 3 can control the second and third selectors 6, 7 to automatically connect the storage device 1, image output device 8, and sound output device 9 back to the computer system 3 to resume the computer system 3.

The input device 4 of the computer system 3 further comprises a press key 42, such that the control of the press key 42 can be started to enter the computer system 3 into an audio/video playback mode.

The computer system 3 further comprises a remote control 32, such that the control of the remote control can be started to enter the computer system 3 into an audio/video playback mode.

The present invention further comprises a fourth selector 10 including but not limited to a demultiplexer, which has an input end 101 and two output ends 102, 103. The input end 101 is coupled to the output end of the input device 4, and the first output end 102 is coupled to the computer system 3, and the second output end 103 is coupled to the audio/video playback controller 5, such that the audio/video playback controller 5 can simultaneously accept the input of the input device 4.

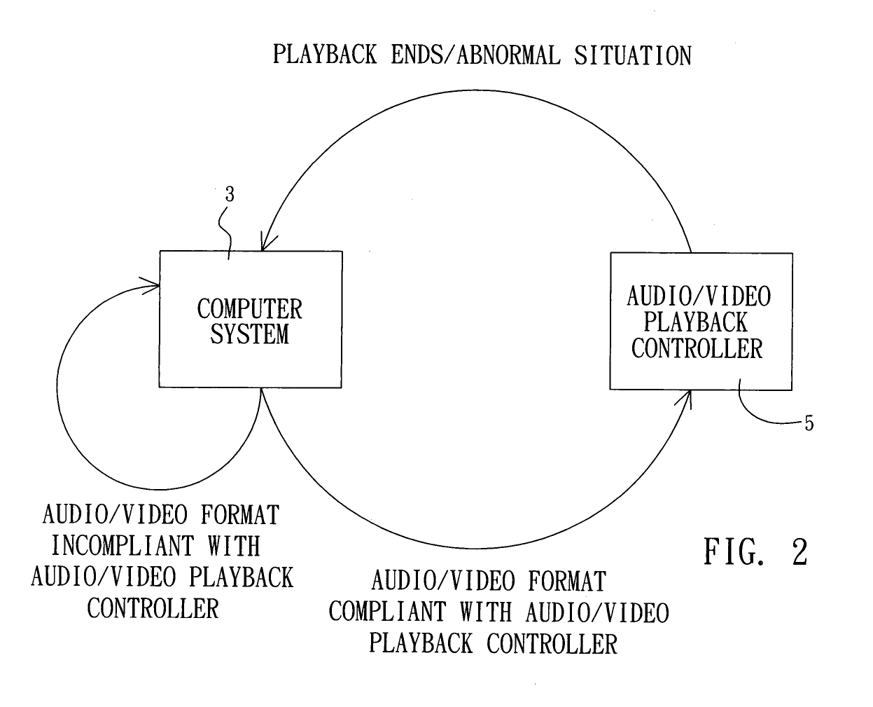

Refer to FIG. 2 for the schematic view of the status of an audio/video control mechanism according to a preferred embodiment of the present invention. When the audio/video control mechanism of the invention is in use, and the computer system 3 receives an audio/video playback request signal and indicates the desired audio/video file in the storage device 1 for the playback, the CPU 31 of the computer system 3 will check the type of the audio/video file first. If the audio/video playback controller 5 is playable, then the computer system 3 will pass the audio/video playback right to the audio/video playback controller 5 for the playback, or else the computer system 3 will play the audio/video file by software. If the computer system 3 confirms that the type of the audio/video file is playable by the audio/video playback controller 5, then the computer system 3 will send a control signal, at least one playback parameter, a storage device parameter, parameters of image and sound output devices 8, 9 to the audio/video playback controller 5. The playback parameter includes but not limited to a language/subtitle selection. The storage device parameter is an operating parameter of the storage device 1, a data directory location, or a track or sector number of a hard disk drive. The parameter of the sound output device 9 includes stereo sound, Dolby, and 5.1 or 7.1 surround sound. The parameter of the image output device 8 includes a VGA/S-Terminal/DVI/HDMI, NTSC/PAL and SD/HD, etc.

After the computer system 3 sends the control signal to the audio/video playback controller 5, the computer system 3 will control the second and third selectors 6, 7 to automatically connect the storage device 1, image output device 8, and sound output device 9 back to the computer system 3, if the audio/video playback controller 5 does not normally send an acknowledge signal to the computer system 3 after a certain specific time. If the audio/video playback controller 5 finds any abnormality including but not limited to a data storage hardware abnormality, a data format error, an incompliant data format to the audio/video playback controller, or a non-indexed data, then the audio/video playback controller 5 will send a signal to the computer system 3 and controls the second and third selectors 6, 7 to connect the storage device 1, image output device 8, and sound output device 9 back to the computer system 3. When the audio/video playback controller 5 successfully starts the audio/video playback, an acknowledge signal should be sent to the computer system 3. The computer system 3 will enter into a sleep mode or will be turned off, only if it has received the acknowledge signal.

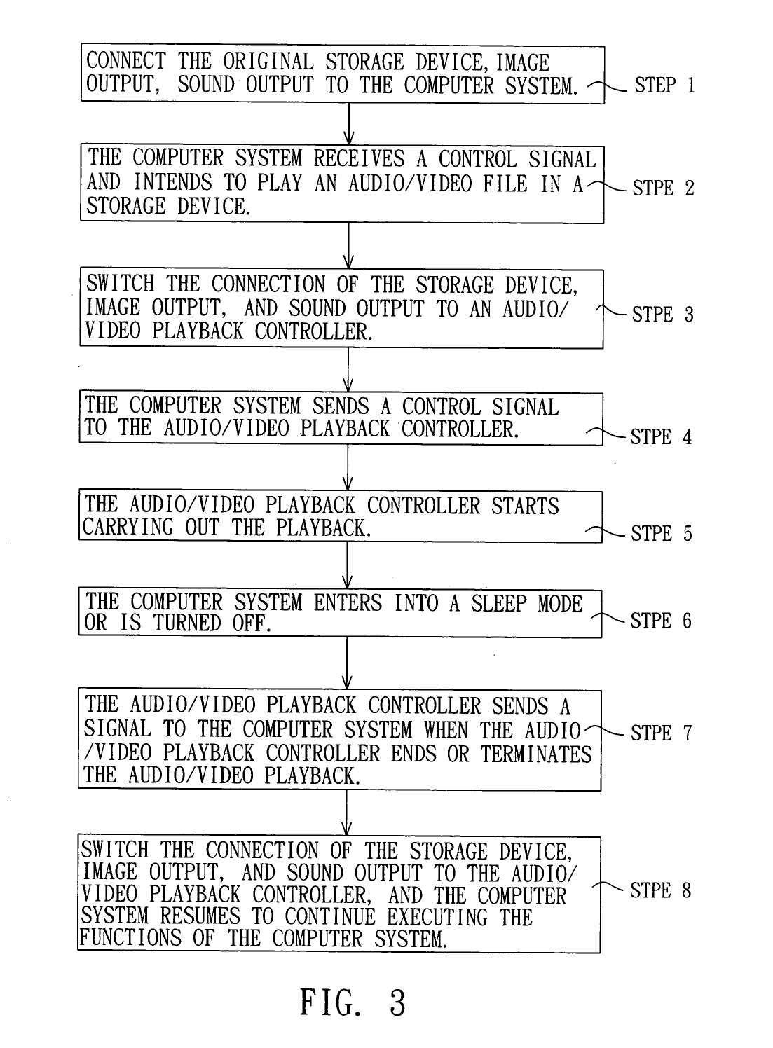

Referring to FIG. 3 for a flow chart of the audio/video control method according to a preferred embodiment of the present invention, the audio/video control method of the invention comprises the steps of: connecting an image output and a sound output of a storage device 1 to a computer system 3 (Step 1); the computer system 3 receiving an audio/video playback request signal and indicating the desired audio/video file in the storage device 1 for the playback (Step 2); switching the connection of the image output and the sound output of the storage device 1 to an audio/video playback controller 5 (Step 3); the computer system 3 sending a control signal to the audio/video playback controller 5 (Step 4); the audio/video playback controller 5 starting the audio/video playback (Step 5); the computer system 3 entering into a sleep mode of being turned off (Step 6); the audio/video playback controller 5 sending out an end signal to the computer system 3 when the audio/video playback ends or terminates (Step 7); and switching the connection of the image output and the sound output of the storage device 1 to the computer system 3, and the computer system 3 resuming from its sleep mode or shutdown and continuing the execution of other functions.(Step 8)

In Step 1 illustrated in FIG. 1, the image output and sound output of a storage device 1 are connected to a computer system 3 through a first selector 2.

In Step 2, the computer system 3 indicates the desired audio/video file in the storage device 1 for the playback when the computer system 3 has received an audio/video playback request signal. The audio/video playback request could come from the remote control 32, hot key 41, or press key 42, etc. In Step 2, the computer system 3 will check the file type of the desired audio/video file in the storage device 1 for the playback first. If the format including but not limited to MPEG2 or MPEG4 is playable by the audio/video playback controller 5, the computer system 3 will pass the audio/video playback right to the audio/video playback controller 5 for the playback, or else the computer system 3 will play the audio/video file by software.

In Step 3, the image output and the sound output of the storage device 1 are connected to the audio/video playback controller 5 by the control of the second selector 6 and the third selector 7 instead; wherein the second selector 6 and the third selector 7 include but not limited to a multiplexer.

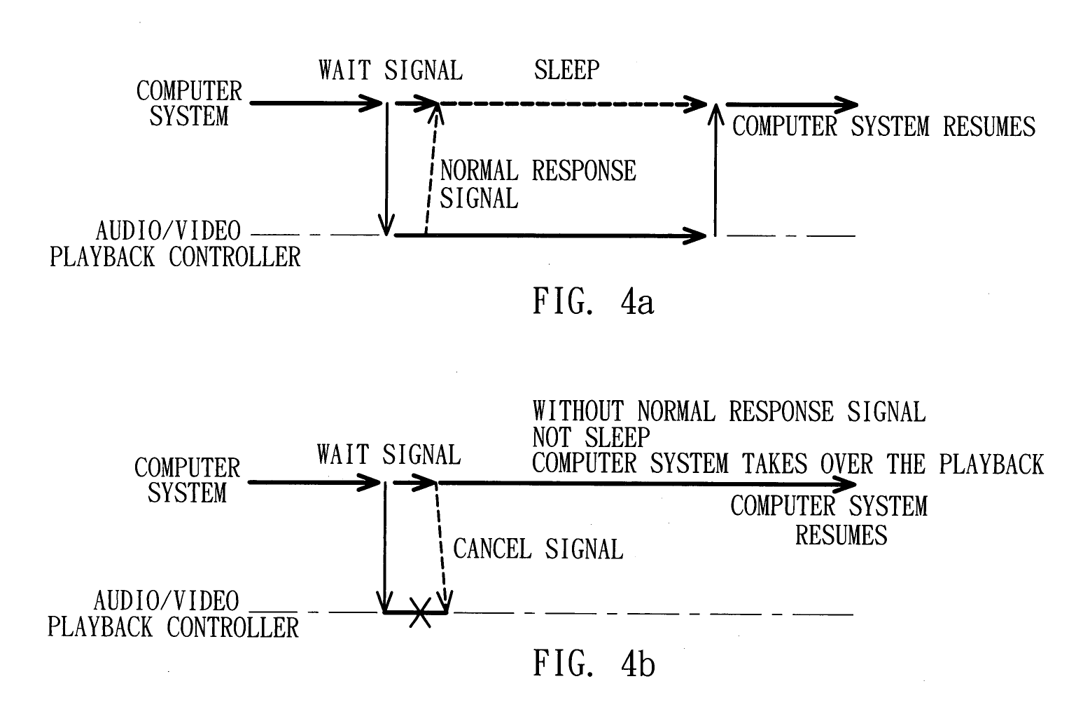

In Step 4, the computer system 3 sends a control signal to the audio/video playback controller 5 to inform the audio/video playback controller 5 to carry out the audio/video playback procedure. After the computer system 3 confirms that the type of audio/video file is playable by the audio/video playback controller 5, the computer system 3 will send a control signal, at least one playback parameter, a storage device parameter, and parameters of image and sound output devices 8, 9 to the audio/video playback controller 5. The playback parameter includes but not limited to a language/subtitle selection. The storage device parameter is an operating parameter of the storage device 1, or a data directory location, a track or section number of a hard disk drive. The parameter of the sound output device 9 includes stereo sound, Dolby, and 5.1 or 7.1 surround, etc, and the parameter of the image output device 8 includes VGA/S-Terminal/DVI/HDMI, NTSC/PAL, and SD/HD, etc. Refer to FIGS. 4A and 4B for the schematic views of the computer system 3 sending out a control signal and then waiting for the response from the audio/video playback controller 5 according to the audio/video control method of a preferred embodiment of the present invention. In FIG. 4A, if the computer system 3 sends a control signal to the audio/video playback controller 5 and the audio/video playback controller 5 responds a signal to the computer system 3 within a predetermined time, then the computer system 3 will enter into a sleep mode. In 4B, if the computer system 3 sends a control signal to the audio/video playback controller 5 and the audio/video playback controller 5 does not send a response signal to the computer system 3 within a predetermined time, then the computer system 3 will control the second selector 6 and the third selector 7 to connect the storage device 1, image output device 8, and sound output device 9 back to the computer system 3. The CPU 31 of the computer system 3 will resume its normal status and take over the playback procedure of the audio/video file.

In Step 5, if the audio/video playback controller 5 starts carrying out the audio/video playback and finds an abnormal situation including but not limited to a data storage hardware abnormality, a data format error, an incompliant data format of the audio/video playback controller and a non-indexed data, etc, then the audio/video playback controller 5 will send a signal to the computer system 3. The computer system 3 will control the second selector 6 and the third selector 7 to connect the storage device 1, image output device 8, and sound output device 9 back to the computer system 3.

In Step 6, if the audio/video playback controller 5 successfully starts carrying out the audio/video playback, the audio/video playback controller 5 will return an acknowledge signal to the computer system 3. The computer system 3 will enter the sleep mode or will be turned off only if the acknowledge signal is received.

In Step 7, the audio/video playback controller 5 sends an end signal to the computer system 3 when the audio/video playback ends or terminates.

In Step 8, the computer system 3 controls the second selector 6 and the third selector 7 to connect the storage device 1, image output device 8, and sound output device 9 to the computer system 3, and the computer system 3 will resume from the sleep mode or shutdown and continue the execution of other functions.

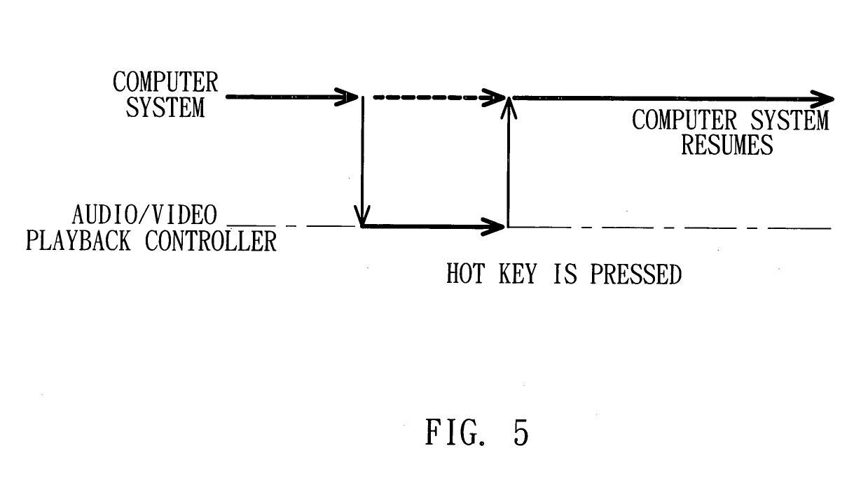

Refer to FIG. 5 for the schematic view of a playback procedure when the audio/video control method of the present invention is triggered by a special event including but not limited to the situation of pressing a hot key 41, the central processing unit 31 of the computer system 3 resumes its normal operation and takes over the playback procedure of the audio/video file. In FIG. 5, if the audio/video playback controller 5 carries out the audio/video playback and a special event is triggered including but not limited to the situation of pressing a hot key 41, the CPU 31 of the computer system 3 will resume its normal operation and take over the playback procedure of the audio/video file.

With the practice of the invention, the audio/video playback function originally carried out under the PC mode and executed by the CPU of the PC is now carried out by the audio/video playback controller instead. In the audio/video playback, the PC automatically enters into a sleep mode or a shutdown mode. Since the audio/video playback controller has low power consumption, therefore no heat dissipation is required and it can save energy and avoid the noise produced by a fan. If the audio/video playback controller stops running, the PC will be waken to resume its original status. If the audio/video playback controller cannot play a file with an incompliant format, then the PC will play the file by software. The present invention definitely overcomes the shortcomings of the prior art CD or DVD playback functions.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio/video control method, comprising the steps of:
connecting an image output and a sound output of a storage device to a computer system;
said computer system receiving an audio/video playback request signal and indicating a desired audio/video file in said storage device to be played;
switching the connection of said image output and sound output of said storage device to an audio/video playback controller;
said computer system sending a control signal to said audio/video playback controller;
said audio/video playback controller starting said audio/video playback; and
said audio/video playback controller sending an end signal to said computer system after said audio/video playback ends or terminates.

2. The audio/video control method of claim 1, wherein said step of said computer system receiving said audio/video playback request and indicating said desired audio/video file in said storage device to be playback further comprises a step of said computer system checking a file format of said desired audio/video file in said storage device first; if said file format is playable by said audio/video playback controller, then said computer system will pass an audio/video playback right to said audio/video playback controller for said playback, or else said computer system will play said audio/video file by software.

3. The audio/video control method of claim 1, wherein said step of said computer system sending said control signal to said audio/video playback controller further comprises a step of said computer system transmitting at least a playback parameter to said audio/video playback controller while sending said control signal to said audio/video playback controller.

4. The audio/video control method of claim 3, wherein said playback parameter is a language/subtitle selection.

5. The audio/video control method of claim 1, wherein said step of said computer system sending said control signal to said audio/video playback controller further comprises a step of said computer system transmitting a storage device parameter to said audio/video playback controller while sending said control signal to said audio/video playback controller.

6. The audio/video control method of claim 5, wherein said storage device parameter is an operating parameter or a data directory location of said storage device.

7. The audio/video control method of claim 6, wherein said operating parameter of said storage device is a sector number or a track number of a hard disk drive.

8. The audio/video control method of claim 1, wherein said step of said computer system sending said control signal to said audio/video playback controller further comprises a step of said computer system transmitting an output device parameter to said audio/video playback controller while sending said control signal to said audio/video playback controller.

9. The audio/video control method of claim 8, wherein said output device parameter further comprises a sound device output or an image output device parameter.

10. The audio/video control method of claim 1, wherein said step of said computer system sending said control signal to said audio/video playback controller further comprises a step of automatically connecting said storage device, said image output device, and said sound output device back to said computer system after said computer system has sent said control signal to said audio/video playback controller and receives no response signal from said computer system within a predetermined time.

11. The audio/video control method of claim 1, wherein said step of said audio/video playback controller starting said audio/video playback further comprising a step of said audio/video playback controller sending a signal to said computer system and automatically connecting said storage device, said image output device, and said sound output device back to said computer system if an abnormal situation is found.

12. The audio/video control method of claim 11, wherein said abnormal situation is a data storage hardware abnormality, a data format error or a non-indexed data.

13. The audio/video control method of claim 11, wherein said abnormal situation is an incompliant data format for said audio/video playback controller.

14. The audio/video control method of claim 1, wherein said step of said audio/video playback controller starting said audio/video playback further comprises a step of returning an acknowledge signal to said computer system when said audio/video playback controller successfully starts said audio/video playback and said computer system will enter into a sleep mode or will be turned off only if said acknowledge signal is received.

15. The audio/video control method of claim 14, wherein said step of said audio/video playback controller sending out an end signal to said computer system further comprises a step of said computer system resuming from said sleep mode or shutdown and continuing the execution of other functions.

16. The audio/video control method of claim 1, wherein said computer system further comprises a hot key, and when said hot key is pressed, said storage device, said image output device, and said sound output device are automatically connected to said computer system to resume said computer system.

17. The audio/video control method of claim 1, wherein said computer system further comprises a press key, and the control of said press key is used to enter said computer system into an audio/video playback mode once said computer system is turned on.

18. The audio/video control method of claim 1, wherein said computer system further comprises a remote control, and the control of said remote control is used to enter said computer system into an audio/video playback mode once said computer system is turned on.

19. The audio/video control method of claim 1, wherein said audio/video playback controller enters into a sleep mode if no audio/video playback request is received.

20. The audio/video control method of claim 1, wherein said step of said audio/video playback controller receives an input from a peripheral device while carrying out said audio/video playback.

21. An audio/video control mechanism, comprising:
a storage device, for storing at least one audio/video file;
a first selector, having its input end coupled to an output end of said storage device;
a computer system, coupled to a first output end of said first selector;
an input device, coupled to said computer system;
an audio/video playback controller, coupled to a second output end of said first selector and said computer system for carrying out a handshaking procedure with said audio/video playback controller;
a second selector, having its first input end coupled to an output end of said computer system and its second input end coupled to an output end of said audio/video playback controller;
a third selector, having its first input end coupled to an output end of said computer system, and its second input end coupled to an output end of said audio/video playback controller;
an image output device, coupled to an output end of said second selector for outputting an image; and
a sound output device, coupled to an output end of said third selector for outputting a sound;
thereby said mechanism enables said computer system to automatically pass the control right of playing an audio/video file to said audio/video playback controller according to the audio/video playback requirements and file format.

22. The audio/video control mechanism of claim 21, wherein said storage device is a hard disk drive or an optical disk drive.

23. The audio/video control mechanism of claim 21, wherein said computer system checks the type of said audio/video file after receiving an audio/video playback request signal and indicating a desired audio/video file in said storage device for a playback; if said audio/video file is playable by said audio/video playback controller, then said computer system will pass a playback control right to said audio/video playback controller for said playback, or else said computer system will play said audio/video file by software.

24. The audio/video control mechanism of claim 23, wherein said computer system sends a control signal and at least one playback parameter to said audio/video playback controller, if the type of said audio/video file is confirmed as playable by said audio/video playback controller.

25. The audio/video control mechanism of claim 24, wherein said playback parameter is a language/subtitle selection.

26. The audio/video control mechanism of claim 24, wherein said computer system further transmits a storage device parameter to said audio/video playback controller.

27. The audio/video control mechanism of claim 26, wherein said storage device parameter is an operating parameter of said storage device, a data directory location, or a track number or a sector number of a hard disk drive.

28. The audio/video control mechanism of claim 24, wherein said computer system further transmits an output device parameter to said audio/video playback controller.

29. The audio/video control mechanism of claim 28, wherein said output device parameter further comprises a sound device output parameter.

30. The audio/video control mechanism of claim 28, wherein said output device parameter further comprises an image device output parameter.

31. The audio/video control mechanism of claim 24, wherein said computer system controls said second and third selectors to automatically connect said storage device, said image output device, and said sound output device back to said computer system after said computer system sends said control signal to said audio/video playback controller and receives no response signal from said audio/video playback controller to said computer system within a predetermined time.

32. The audio/video control mechanism of claim 24, wherein said audio/video playback controller sends a signal to said computer system and controls said second and third selectors to automatically connect said storage device, said image output device, and said sound output device back to said computer system, if said computer system finds an abnormal situation after sending said control signal to said audio/video playback controller.

33. The audio/video control mechanism of claim 32, wherein said abnormal situation includes an abnormal situation of a data storage hardware, a data format error or a non-indexed data.

34. The audio/video control mechanism of claim 32, wherein said abnormal situation includes an abnormal situation of a data format incompliant with said audio/video playback controller.

35. The audio/video control mechanism of claim 23, wherein said computer system enters into a sleep mode or is turned off, only if said audio/video playback controller successfully carries out said audio/video playback and sends an acknowledge signal to said computer system and said computer has received said acknowledge signal.

36. The audio/video control mechanism of claim 35, wherein said computer resumes from said sleep mode or shutdown to continue the execution of other functions, if said audio/video playback controller sends an end signal to said computer system.

37. The audio/video control mechanism of claim 21, wherein said computer system further includes a hot key, so that when said hot key is pressed, said computer system controls said second and third selectors to automatically connect said storage device, said image output device, and said sound output device back to said computer system to resume said computer system.

38. The audio/video control mechanism of claim 21, wherein said computer system further includes a press key, and the control of said press key is used to enter said computer system into an audio/video playback mode once said computer system is turned on.

39. The audio/video control method of claim 21, wherein said computer system further comprises a remote control, and the control of said remote control is used to enter said computer system into an audio/video playback mode once said computer system is turned on.

40. The audio/video control method of claim 23, wherein said audio/video playback controller enters into a sleep mode to save electric power if said audio/video playback controller receives no audio/video playback request.

41. The audio/video control method of claim 21, further comprising a fourth selector, and its input end being coupled to said input device, and its first output end being coupled to said computer system, and its second output end being coupled to said audio/video playback controller, such that said audio/video playback controller is capable of receiving an input of said input device at the same time.
